(19) United States
(12) Patent Application Publication
(10) Pub. No.: US 2014/0318874 A1
(43) Pub. Date: Oct. 30, 2014

(54) CONFIGURABLE ELECTRONIC KITCHEN SCALE ACCESSORY

(71) Applicant: QUALCOMM Incorporated, San Diego, CA (US)

(72) Inventors: Daniel Moses, San Diego, CA (US); Pouyan Farasati, San Diego, CA (US); Tia Manning Cassett, San Diego, CA (US); Candice Ruth Mudrick, San Diego, CA (US); Milivoje Aleksic, San Diego, CA (US)

(73) Assignee: QUALCOMM Incorporated, San Diego, CA (US)

(21) Appl. No.: 14/074,569

(22) Filed: Nov. 7, 2013

Related U.S. Application Data
(60) Provisional application No. 61/817,824, filed on Apr. 30, 2013.

(51) Int. Cl. G01G 19/414

(52) U.S. Cl. CPC G01G 19/414
USPC 177/1; 177/25.13

(57) ABSTRACT

Systems, devices, apparatus, and methods for a configurable kitchen scale accessory are disclosed. The scale may include a detachable transparent measurement panel detachably secured to a frame. The frame may include a plurality of force sensors. The scale may be configured to determine a weight of a measured ingredient placed on the measurement panel and display the weight or an equivalent volume of the measured ingredient by utilizing conversion tables stored within an electronic memory of the scale. The scale may be further configured to connect to an interactive display to transmit weights and volumes and receive a list of ingredients for a selected recipe.

### INCORPORATION BY REFERENCE TO ANY RELATED APPLICATIONS

Any and all applications for which a foreign or domestic priority claim is identified in the Application Data Sheet as filed with the present application are hereby incorporated by reference under 37 CFR 1.57.

This application claims the benefit of priority under 35 U.S.C. §119(e) of U.S. Provisional Patent Application No. 61/817,824, filed Apr. 30, 2013, titled “CONNECTED KITCHEN SCALE ACCESSORY,” the disclosure of which is hereby incorporated by reference in its entirety.

### TECHNICAL FIELD

The devices, systems and methods disclosed herein relate generally to configurable and programmable electronic kitchen scales, and more particularly to configurable and programmable electronic kitchen scales connected to an interactive display system.

### BACKGROUND

Electronic media devices are finding their way into the kitchen, as more people cook and consume media content simultaneously, such as browsing the internet for a recipe. Designing display devices specifically for use in the kitchen offers opportunities to change the way people cook by offering a more streamlined, interactive experience. However, limitations on the cooking experience remain due to the inability of recipes to automatically adjust to user-specific needs and the need for multiple kitchen accessories for measurement of ingredients in a variety of units, such as cups, teaspoons, tablespoons, etc.

One solution to this problem has been the use of a single scale that may be used for measuring all ingredients in a recipe. However, current implementations require a companion conversion table between the measured value and the weight for each type of ingredient. Further, if a user intends to prepare a different number of servings than specified in the recipe, the user must manually recalculate all of the ingredients in the recipe.

### SUMMARY

The systems, methods, and devices of the present disclosure each have several innovative aspects, no single one of which is solely responsible for the desirable attributes disclosed herein.

In order to address these needs, the connected kitchen system described herein may include a scale capable of communication with a media center. The media center may be a display adapted for use in a kitchen setting, for example any of the displays described in U.S. patent application Ser. No. 13/779,429, U.S. patent application Ser. No. 13/779,201, or U.S. patent application Ser. No. 13/779,158. A user may select a recipe to be presented on the display and ingredient-specific measurement commands may be sent to the scale. The command may include the amount of the ingredient specified by the recipe and this amount may be converted to the expected weight of the ingredient at the specified amount by either the display or the scale. The scale may send measured weights to the display for presentation to the user. The scale can also send a “key ingredient” command to the display, causing the display to adapt the recipe to the actual measured amount of the current ingredient on the scale. The scale may also provide an indication to the user to indicate when the desired ingredient weight has been reached. The scale may also be used by itself as a standard digital kitchen scale.

In one aspect, a configurable electronic scale includes a frame structure, a measurement panel mounted on the frame structure, at least one force sensor coupled to the frame structure and configured to measure a weight of an item placed on the measurement panel, and a processor configured to convert the measured weight of the item into an equivalent volume and provide an indication of the amount of the item placed on the scale.

In another aspect, a measurement system includes a display configured to display a recipe comprising at least one ingredient and a corresponding recipe ingredient amount and a scale in communication with the display. The scale is configured to receive the recipe ingredient amount from the display, measure an amount of ingredient placed on the scale by a user, and provide an indication of the amount of ingredient placed on the scale.

In yet another aspect, a measurement system includes an interactive display configured to display a recipe comprising a plurality of ingredients, each of the plurality of ingredients having a corresponding recipe ingredient amount and a scale in communication with the display. The scale is configured to measure an amount of a key ingredient placed on the scale by a user, wherein the key ingredient is one of the plurality of ingredients, and provide the measured key ingredient amount to the display. The display is configured to scale the corresponding recipe ingredient amounts according to a ratio between an amount specified in the recipe for the key ingredient and the measured key ingredient amount.

In another aspect, a method for weighing a series of recipe ingredients includes the steps of providing a configurable scale having a scale display and a measurement panel detachably secured to a frame structure, wherein a set of force sensors are configured to detect a weight of a first ingredient placed on the measurement panel, receiving a configuration instruction from an interactive display, and weighing the first ingredient and displaying one or both of a weight and a volume of the first ingredient on the scale display. The method also includes the steps of transmitting one or both of the weight and volume of the first ingredient to the interactive display, scaling a required weight or volume of a second ingredient based on the weight or volume of the first ingredient, weighing the second ingredient and displaying one or both of a weight and a volume of the second ingredient on the scale display, and transmitting one or both of the weight and volume of the second ingredient to the interactive display.

### BRIEF DESCRIPTION OF THE DRAWINGS

The disclosed aspects will hereinafter be described in conjunction with the appended drawings and appendix, provided to illustrate and not to limit the disclosed aspects, wherein like designations denote like elements.

FIG. 1 is a front perspective view of a connected kitchen scale accessory, according to one implementation.

FIG. 2 is a top view of a connected kitchen scale accessory.

FIG. 3 is a schematic cross sectional view of the connected kitchen scale accessory of FIG. 1.

FIG. 4 is a schematic diagram of a connected kitchen scale accessory connected to a display system and computer, according to one implementation.

FIG. 5 is a view of the display of a connected kitchen scale accessory.

FIG. 6 is a schematic block diagram depicting a connected kitchen scale accessory implementing some operative elements.

FIG. 7 is a diagram illustrating an embodiment of a communication process between a display device and a connected kitchen scale accessory.

FIG. 8 is a flow chart illustrating a configurable weighing process, according to one implementation.

### DETAILED DESCRIPTION

### Kitchen Scale Device Overview

Implementations disclosed herein provide systems, devices, and apparatus for an electronic configurable kitchen scale accessory. For example, in one embodiment, the scale may have a bezel-less transparent measurement panel supported on a frame structure. A plurality of force sensors may be used to register a weight of an ingredient placed on the measurement panel. The frame structure may include a display and a plurality of buttons that may be manipulated by a user to display a weight or volume of the measured ingredient. The scale may be connected wirelessly or through display wires to a display device such that a user may browse the interne for recipes and adapt recipe ingredient amounts based on the weight of a key ingredient transmitted from the connected scale. The scale may contain a memory and a processor running instructions from a conversion module such that the scale may be configured to perform weight and volume conversions for common ingredients, such as converting a cup of an amount of material into a similar weight of that material. Accordingly, the kitchen scale accessory may be configured to convert, for example, a desired cup of flour in a recipe into a desired weight of flour so that the scale accessory can be used to measure out the proper amount of the flour corresponding to one cup.

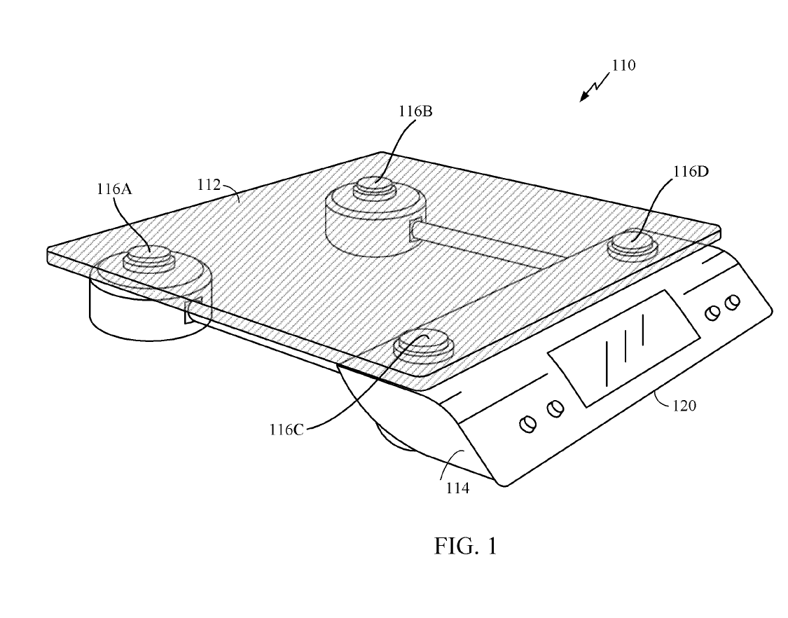

As illustrated in FIG. 1, a configurable kitchen scale accessory 110 may have a measurement panel 112, a frame structure 114 comprising a scale display 120, and a set of force sensors 116A-D. The force sensors 116A-D may be located on the frame structure 114 or on the underside of the measurement panel 112. The measurement panel 112 may be made out of transparent or semi-transparent glass, and may comprise one substantially flat planar surface with no bezel. In some embodiments, the measurement panel 112 may be made out of other materials such as plastic, resin, wood, or metal. In some embodiments, the panel 112 may be detachably secured to the frame structure of the scale, for example by magnets. Depending on the weight of the panel 112, no connection mechanism may be required as gravity may suffice to secure the panel 112 to the scale frame structure 114. A bezel-less and/or detachable panel would be easily cleanable, as the panel will likely accumulate residue of the ingredients which the scale is used to weigh. Some embodiments may further comprise a container which may be placed over the panel 112 to measure large quantities or fluidic ingredients.

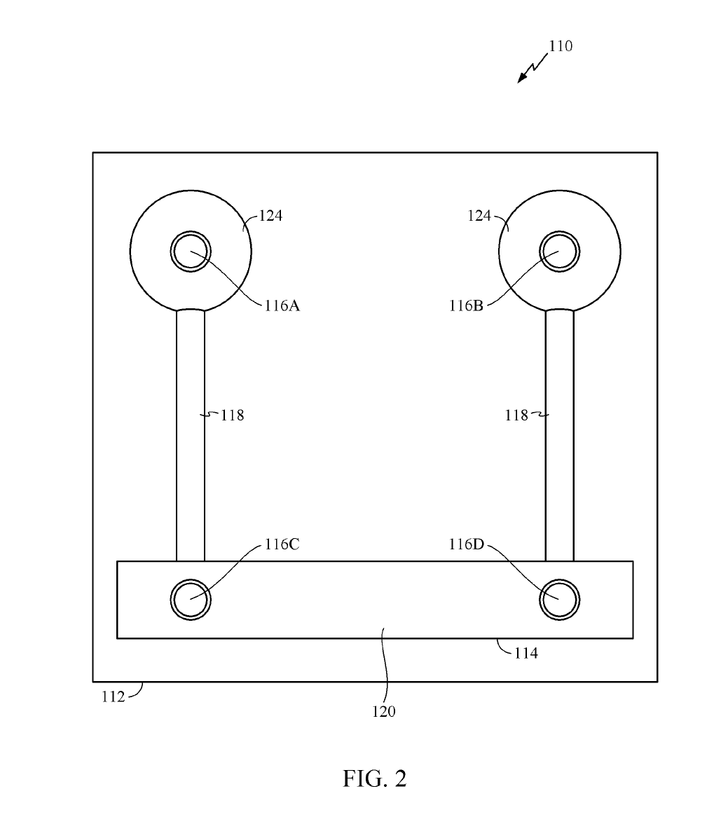

FIG. 2 illustrates a top view of the kitchen scale accessory 110 wherein the elements below the accessory 110 can be seen through the measurement panel 112, which may be semi-transparent or transparent. The frame structure 114 below the measurement panel 112 may have a scale display component 120 and at least two legs 118 extending from the scale display 120, forming a U-shape. A support 124 may be located at one end of each leg 118. Force sensors 116A-D may be located on each end of the scale display 120 and in each support 124. While a rectangular-shaped measurement panel 112 and U-shaped frame structure 114 is shown in FIG. 2, other shapes may also be possible, such as, for example, circular, oval, elliptical, or square.

In some embodiments, the measurement panel 112 may be coupled to the frame structure 114 such that it entirely covers the upper surface of the frame structure. The measurement panel 112 may be detachably secured to the frame structure 114 by a magnetic coupling between the measurement panel 112 and the frame structure 114. In one embodiment, magnets may be bonded to the underside of the measurement panel 112 to assist with placement and alignment of the measurement panel 112 on the frame structure 114. The magnets may be placed near the force sensors 116A-D or may be placed at other points on the frame structure 114.

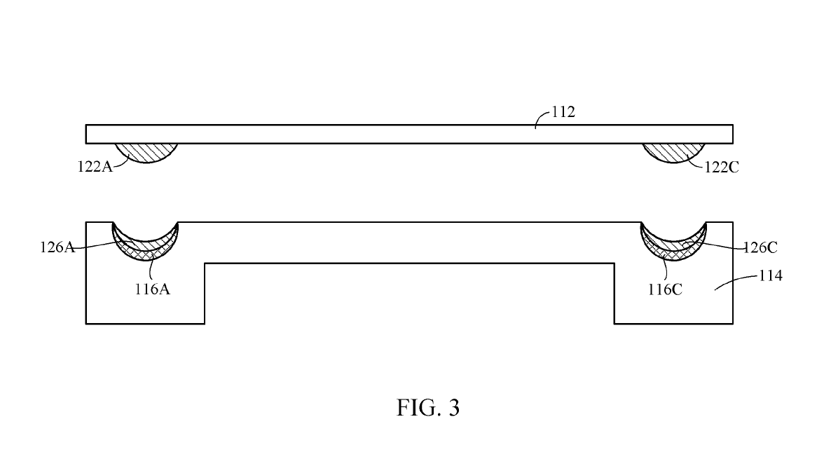

Referring now to the side cross-sectional view of the scale as shown in FIG. 3, magnets 122A and 122C are shown bonded to the underside of the measurement panel 112 near the corners of the panel. Corresponding magnets 126A and 126C may be located within notches in the frame structure 114 such that the magnets bonded to the measurement panel 112 can sit within the notches of the frame structure 114 to detachably secure the measurement panel 112 to the frame structure 114. In some embodiments, the magnetic coupling of the measurement panel 112 to the frame structure 114 may also be achieved through a combination of magnets and a magnetically attractive material. This magnetic coupling allows the measurement panel 112 to be easily removed from the frame structure 114 to transfer ingredients during cooking or to be washed after use.

Force sensors 116A-D may also be placed within the notches in the frame structure 114 to measure the weight of recipe ingredients. In the cross-sectional view of the scale accessory shown in FIG. 3, force sensors 116A and 116C are disposed within the notches in the frame structure 114 and align with magnets 122A and 122C respectively. Since ingredients may not be placed exactly in the center of the measurement panel 112, the scale 110 may have a processor configured to perform calculations based on the pressure or force signals received from each of the force sensors to determine the weight of the measured ingredient. The scale may be configured to automatically zero out or register a weight of zero grams when placement of the measurement panel 112 on the frame structure 114 is detected. In other embodiments, the user can press a button on the scale display to compensate for the weight of the measurement panel 112 and prepare the scale to weigh recipe ingredients.

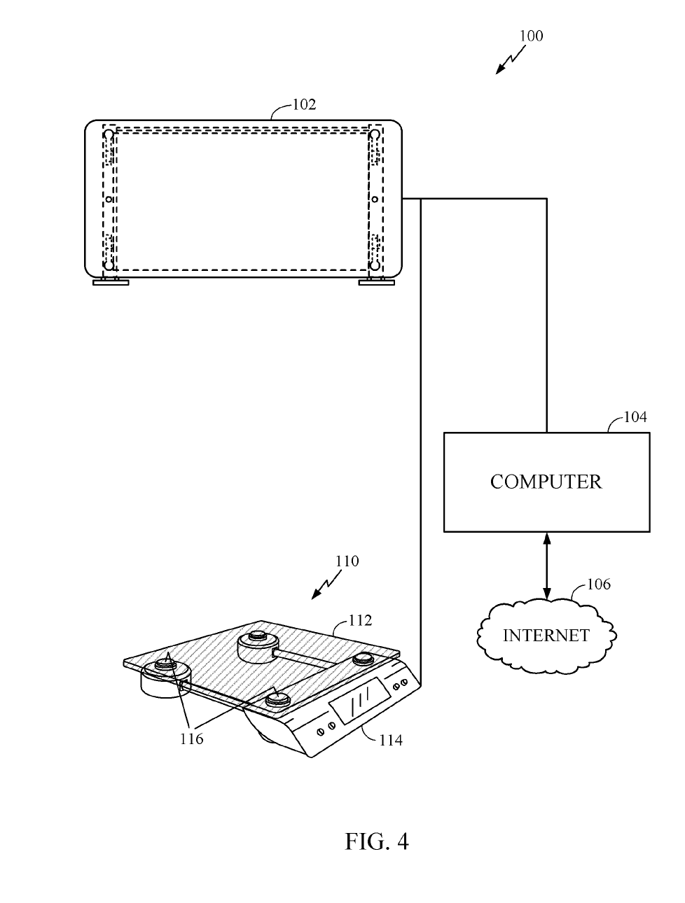

In some embodiments, the kitchen scale accessory may be part of a connected kitchen media system. FIG. 4 illustrates one embodiment of an interactive kitchen media system 100 comprising the scale accessory 110, an interactive display 102, and a computer 104 connected to the internet 106. The scale accessory 110 and display 102 may be configured to communicate information, for example, regarding desired and actual weights or amounts of recipe ingredients. One exemplary display device is described in U.S. patent application Ser. No. 13/779,429, entitled “INTERACTIVE DISPLAY WITH REMOVABLE FRONT PANEL,” filed on Feb. 27, 2013, the entirety of which is incorporated herein by reference. As will be discussed in greater detail below, the scale 110 may communicate wirelessly with a computer and a display device such that recipe amounts may be adjusted based on the weight of a specified key ingredient.

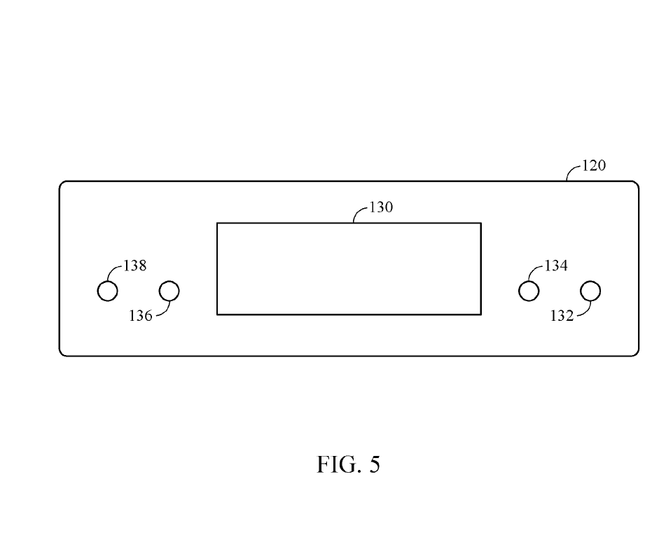

As shown in FIG. 5, the scale display 120 may comprise user interface elements such as, for example, a touch-sensitive LCD display 130 and buttons 134, 136, and 138. The scale display 120 may be used to indicate measured amounts to a user. The scale display 120 may also display the measured amounts in a volume measurement, such as cups or teaspoons, or a weight measurement, such as grams or pounds. The buttons 134, 136, and 138 may be used to toggle between display modes. Although the scale 110 is described as being used together with interactive display 102 shown in FIG. 4, it also may be used independently, as is discussed in further detail below.

With further reference to FIG. 5, the scale display 120 is shown in more detail. The scale display 120 may include a plurality of buttons 134, 136, and 138 one of which may be a recipe adaptation button. When pressed, the recipe adaptation button may cause the values of ingredient weights needed for a current recipe to be recalculated by a processor based on the measured amount of an ingredient currently on the scale. This may be useful when the user has only a limited amount of a key ingredient and wishes to scale the recipe accordingly. This may also be useful when a user wishes to scale the recipe to increase the yield, for example by doubling all of the ingredients. The processor may be a component of the scale accessory 110 or may be a separate processor connected to the scale accessory.

Some embodiments of the scale may further comprise an indicator for providing feedback to the user when the desired weight of the ingredient has been reached. For example, as shown in FIG. 5, the scale display 120 may have an indicator 132, which in one embodiment is an LED light. If the ingredient weight is too low, the LED light may shine a first color to indicate to the user that they should continue adding the ingredient to the scale. When the ingredient weight specified by the recipe has been reached, the LED light may shine a second color, for example green, to indicate to the user that the desired ingredient amount is currently on the scale. If the ingredient weight exceeds the recipe specification by a threshold amount, the LED light may shine a third color to indicate to the user that they must remove some of the ingredient on the scale. It will be appreciated that the indicator 132 could also be any suitable indicator, such as a set of symbols shown on scale display 120 or display 102, or may be an auditory indicator. In some embodiments comprising an auditory indicator 132, the scale may provide linguistic feedback to the user regarding the currently measured ingredient in addition to or instead of a standard numerical indicator (such as ½ cup).

### System Overview

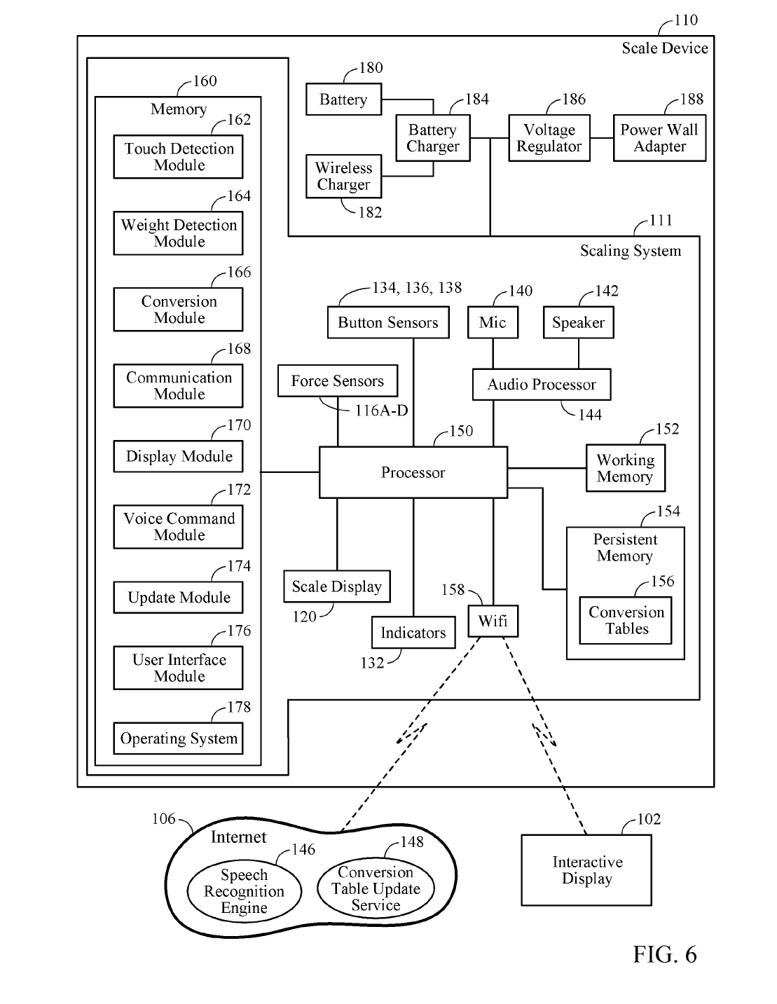

A high-level block diagram of one embodiment of a configurable kitchen scale accessory system 110 is shown in FIG. 6. The scale device 110 may comprise a scaling system 111 and a set of power components including a battery 180, wireless charger 182, battery charger 184, voltage regulator 186, and power wall adapter 188. The battery 180 may be rechargeable with a standard plug-in charger device 184 or may be charged wirelessly via wireless charger 182. Preferably, the battery 180 of the scale device 110 has a long standby time and requires minimal charging. During intensive use, the scale device 110 may be operated with battery power or through a charging component plugged into a conventional wall power outlet, such as power wall adapter 188.

The scaling system 111 may have a set of components including a processor 150 linked to a plurality of force sensors 116A-D, buttons 134, 136, and 138, an indicator 132, and a scale display 120. Additionally, the scale 100 may have a microphone 140 and speaker 142 connected to processor 150 through an audio processor 144. A working memory 152 and memory 160 are also in communication with processor 150. A persistent memory component 154 containing conversion tables 156 may also be in communication with processor 150. The scale 110 may also connect to a computer 104 and/or an interactive display/media server 102 in order to provide additional functions and applications for the scale 110, such as transmission of recipe ingredient amounts, recipe scaling instructions, or weight to volume conversion information for common ingredients. The scale 110 may be a standalone measurement device or may be used in connection with a computer, interactive display, or the internet via a wireless or wired connection such as via Wifi 158. Via the Internet 106, the scale 110 may access a speech recognition engine 146 to enable the scale to process voice commands and/or a conversion table update service 148 to update and expand the conversion tables 156 stored within the persistent memory 154.

Processor 150 may be a general purpose processing unit or a processor specially designed for display and conversion calculation applications. As shown, the processor 150 is connected to a memory 160 and a working memory 152. In the illustrated embodiment, the memory 160 stores a touch detection module 162, a weight detection module 164, a conversion module 166, a communication module 168, a display module 170, a voice command module 172, an update module 174, operating system 178, and user interface module 176. These modules may include instructions that configure the processor 150 to perform various display, touch sensing, ingredient weight detection, conversion functions, and device management tasks. Working memory 152 may be used by processor 150 to store a working set of processor instructions contained in the modules of memory 160. Alternatively, working memory 152 may also be used by processor 150 to store dynamic data created during the operation of scale accessory system 110.

As mentioned above, the processor 150 is configured by several modules stored in the memory 160. Touch detection module 162 includes instructions that configure the processor 150 to detect a user's touch on the scale display 120, the LCD touch sensitive display 130, or on buttons 134, 136, and 138. Therefore, processor 150, along with touch detection module 162 and buttons 134, 136, 138, represent one means for detecting a user's touch on the scale display 120 of the scale accessory 110.

The weight detection module 164 provides instructions that configure the processor 150 to detect a weight of an ingredient placed on the measurement panel 112 of the scale 110. Using the force sensor data from the force sensors 116A-D, the processor 150 can determine the amount of the ingredient placed on the scale and, along with the display module 170, can display the measured amount of the ingredient on the scale display 120. Therefore, processor 150, along with the weight detection module 164 and pressures sensors 116A-D, represent one means for detecting a weight of ingredients placed on the measurement panel 112.

The conversion module 166 provides instructions that configure the processor 150 to convert a detected weight of an ingredient as measured by the force sensors 116A-D to an equivalent volumetric amount. The conversion module 166 can access a common conversion look-up table, such as conversion tables 156 stored in persistent memory 154, listing weight to volume conversion information for common ingredients. In addition, the conversion module 166 may be updatable manually, or automatically, so that additional conversion information for new ingredients may be added into the scale, such as via a conversion table update service 148 accessible over the internet 106.

The communication module 168 provides instructions that configure the processor 150 to communicate with the interactive display 102, external computer 104, and/or the internet 106. The processor 150, along with the communication module 168, can receive recipe ingredient weight or volume information from the interactive display 102, computer 104, and/or the internet 106 and transmit a weight or volume of a measured ingredient to the interactive display 102, computer 104, and/or the internet 106. For example, the processor 150 can further receive key ingredient information from the interactive display 102, computer 104, and/or the internet 106 and transmit recipe scaling information to the display 102, computer 104, and/or the internet 106 based on the weight of the key ingredient as measured by the scale 110. Additionally, the processor 150, along with the communication module 168, can receive key ingredient information from the scale 110. For example, when a user presses a button on the scale 110 to indicate a key ingredient, the scale 110 can transmit recipe scaling information to the display 102, computer 104, and/or the internet 106 based on the weight of the key ingredient as measured by the scale 110. The processor 150, along with the communication module 168 and the conversion module 166, can also access an external memory location or the internet 106 to update the common conversion look-up table in order to provide accurate weight to volume conversion information for uncommon ingredients.

The display module 170 includes instructions that configure the processor 150 to display the weight or volume of a measured ingredient on the scale display 120. The display module 170 may also include instructions to display the name of the ingredient to be weighed, such as “flour.”

The voice command module 172 includes instructions that configure the processor 150 to receive and process spoken commands and instructions. For example, a user may select an ingredient to measure using a voice command. Upon recognition of the voice command, the voice command module 172 may instruct the processor 150 to communicate with a speech recognition engine, such as Google voice recognition engine, to process the voice command.

The update module 174 includes instructions that configure the processor 150 to perform software updates. Additionally, the update module 174 may include instructions that configure the processor 150 to update the conversion tables 156 stored in the persistent memory 154 from information obtained via the Internet 106, a computer 104, or other source.

The user interface module 176 includes instructions that configure the processor 150 to display an indicated amount of a measured ingredient on the indicator 132. The indicator 132 can be an LED indicator that indicates an amount of an ingredient by a graduated display of colored lights. The indicator can also be an auditory indicator that linguistically communicates to the user the weight or volume of a measured ingredient.

Operating system 178 configures the processor 150 to manage the memory and processing resources of system 110. For example, operating system 172 may include device drivers to manage hardware resources such as the scale display 120, buttons 134, 136, 138, indicator 132, or force sensors 116A-D. Therefore, in some embodiments, instructions contained in the scale accessory system modules discussed above may not interact with these hardware resources directly, but instead interact through standard subroutines or APIs located in operating system component 172. Instructions within operating system 172 may then interact directly with these hardware components.

Although FIG. 6 depicts a device comprising separate components to include a processor, a plurality of force sensors, electronic scale display output, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 6 illustrates three memory components, including memory component 160 comprising several modules, a separate memory 152 comprising a working memory, and a persistent memory 154, one with skill in the art would recognize several embodiments utilizing different memory architectures. For example, a design may utilize ROM or static RAM memory for the storage of processor instructions implementing the modules contained in memory 160. Alternatively, processor instructions may be read at system startup from a disk storage device that is integrated into scale accessory system 110 or connected via an external device port. The processor instructions may then be loaded into RAM to facilitate execution by the processor. For example, working memory 152 may be a RAM memory, with instructions loaded into working memory 152 before execution by the processor 150.

### Communication Process Overview

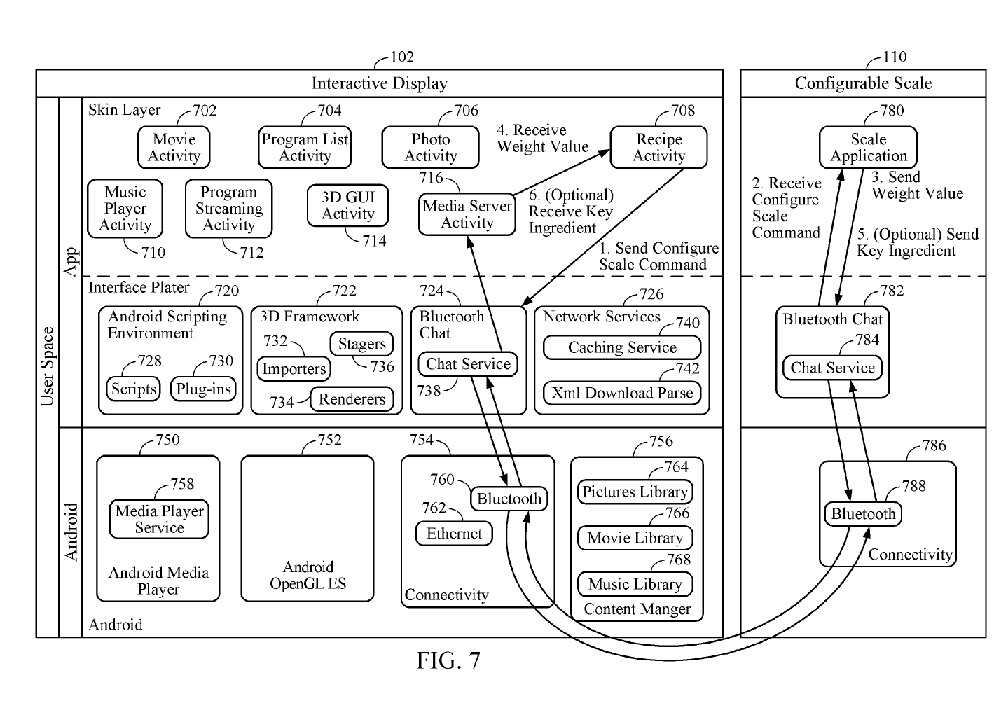

FIG. 7 illustrates one embodiment of a two-way communication process between the configurable scale 110 and an interactive display 102. The interactive display 102 may be configured to perform several functions as shown in FIG. 7, including displaying and adapting a recipe as part of a recipe activity 708. In some embodiments, the interactive display 102 sends configuration commands to the configurable scale 110 to define the unit of the ingredient being measured. For example, the interactive display 102 may send the command to the scale 110 to measure an amount of pasta in a volumetric measurement such as cups rather than a weight such as grams. In response, the configurable scale 110 transmits the weight or volume of the measured ingredient to the interactive display 102. The configuration command may be initiated by a recipe activity 708 on the interactive display or media server 102. The configuration command may be transmitted to the configurable scale 110 using a Bluetooth connection 760 on the interactive display 102 that is configured to connect with a Bluetooth connection 788 on the configurable scale 110. The scale 110 may communicate with the interactive display 102, computer 104, and/or the interne 106 over a wireless connection such as Bluetooth or wifi or through a wired connection.

In some embodiments, the configurable scale 110 may receive information from the interactive display 102 that the measured ingredient is a “key” recipe ingredient. In response, the configurable scale 110 may transmit the measured weight of this key recipe ingredient to the interactive display 102 to force the interactive display 102 to adapt or scale the recipe to this ingredient weight. The recipe may be scaled either up (doubled, tripled, etc.) or down (halved, etc.) depending on the measured amount of the key recipe ingredient. For example, if a user only has a certain amount of flour, a recipe for a cake could be scaled depending on the amount of flour measured by the scale 110. Scaling of the recipe is not limited to doubling, tripling, or halving and may be any fraction or multiple of the recipe depending on the measured amount of the key ingredient. In some embodiments, scaling of the remaining ingredients may not be linear.

In some embodiments, the configurable scale 110 may transmit information to the interactive display 102 that the measured ingredient is a “key” recipe ingredient, such as when a user presses a button on the scale 110 before, during, or after measuring an ingredient. In response, the interactive display 102 may adapt or scale the recipe to the measured ingredient weight. The recipe may be scaled either up or down as described above.

As discussed above, the scale 110 may incorporate a look-up table of weight to volume conversion information for common ingredients within memory storage incorporated into the scale 110. The scale 110 may also communicate with other devices, such as the interactive display 102, the computer 104 or the internet 106 to update or obtain weight to volume conversion information for less-common ingredients.

### Measurement Process Overview

The configurable scale 110 may have a plurality of operation modes. In one mode, independent operation, the scale 110 is not connected to an external display device 102. The scale 110 can weigh and display the weight of a measured ingredient on the scale display 120. In some embodiments, the scale 110 may include voice processing capability to determine and interpret voice commands. Voice commands may be used to select an ingredient to measure or to indicate a desired unit of measurement. Voice commands may enable the user to more easily navigate the stored ingredient conversion table. As discussed above, a voice recognition engine such as Google voice recognition may be accessed over the Internet using a wired or wireless connection.

In another mode of operation, the configurable scale 110 may be connected to an interactive display or media server device 102. The configurable scale 110 may receive a task list of ingredients to measure for a specific recipe from the interactive display 102. The ingredients may be measured one at a time and removed from the measurement panel 112 after they are measured. The user may specify a key ingredient by pressing a button 134, 136, or 138 on the scale 110 before, during, or after an ingredient is measured. This “key ingredient” information may be transferred to the interactive display or media server device 102 and the recipe may be scaled accordingly. In some embodiments, scaling of the recipe may be performed by the configurable scale 110. In some embodiments, the user may indicate a key ingredient via the interactive display or media server device 102. The recipe may be scaled accordingly, either by the interactive display or media server device 102 or by the configurable scale 110. In some embodiments, the measurement panel 112 may be detached and used as a cutting board to further process the ingredient before it is added to a mixing bowl or other meal preparation area.

In yet another mode of operation, a group of ingredients may be added to a measuring bowl or the measurement panel 112 accumulatively and then transferred as a group to another bowl or meal preparation area. In some embodiments, the measurement panel 112 may be a bowl or other shape that may be used to hold recipe ingredients such as liquid ingredients. In some embodiments, the scale 110 may receive a task list of ingredients to measure for a specific recipe from the interactive display 102. The scale 110 may display the name of the ingredient to be measured, such as “flour,” to indicate that this ingredient should be placed on the measurement panel 112. Once this ingredient is weighed and the weight information is transferred to the interactive display 102, the scale 110 may then display the next ingredient to be weighed, such as “sugar.” Thus, in some embodiments, the scale 110 can prompt the user for the next ingredient needed for a specified recipe without requiring the user to constantly relate back to the recipe list for this information. In some embodiments, the scale 110 can also help correct for user error in measuring ingredients. For example, if a user enters too much of a second ingredient, the scale 110 may adapt the ingredient amounts accordingly and prompt the user to increase the amount of one or more of the previous ingredients from the recipe task list in response to the recipe adaptation.

The interactive display 102 may include an option for the user to select a current ingredient from a list, or an option for the user to manually input the current ingredient, so that the scale 110 may accurately determine the quantity of the ingredient from a data store of known ingredient weight-to-volume conversions. For example, the user may select the ingredient “flour,” and the scale 110 may retrieve data indicating that the preferred weight of one cup of flour is 4.25 ounces. Thus, the scale 110 may detect a weight of flour and output the volume, for example by displaying “1 cup” on either the scale display 114 or on the connected interactive display 102. If an ingredient is not provided with conversion data, a user may be able to manually enter conversion data and the scale 110 may store that data for future use. Because the scale 110 measures weights while recipe ingredients are commonly measured in volume, such as cups or teaspoons, this feature provides a user with a means of easily comparing the current ingredient amount on the scale 110 with the amount needed for the recipe.

In some embodiments, the scale 110 may be configured to determine a preferred output metric based on a variety of factors such as weight or ingredient. For example, an output metric of cups may be determined for large measured quantities of an ingredient or an output metric of teaspoons may be determined for small measured quantities of an ingredient. The scale 110 may also determine the preferred output metric based on the currently measured ingredient, for example teaspoons for baking soda or nutmeg, or cups for flour. Alternatively, the user may be able to specify what metric the scale should use to output ingredient weights, for example by standard units or metric units.

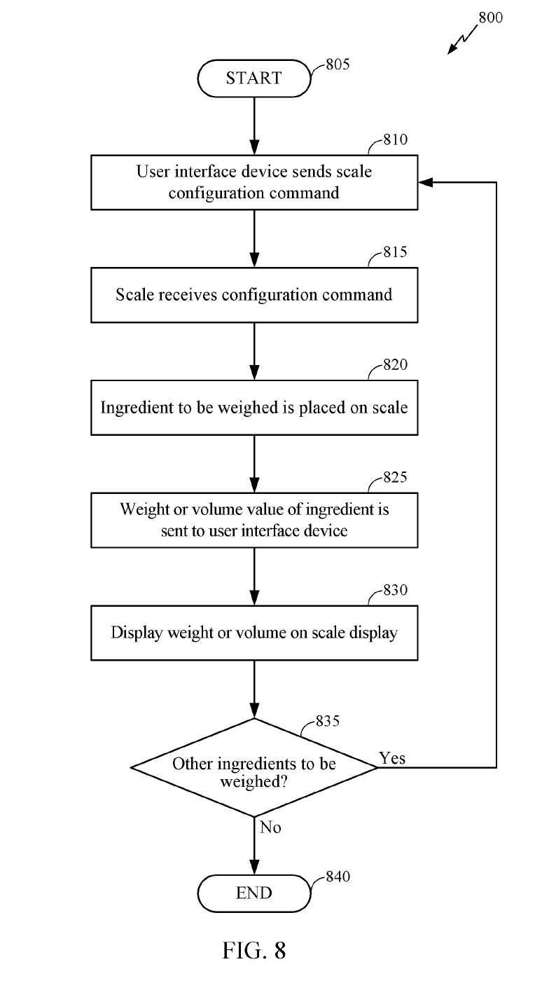

FIG. 8 is a flow chart depicting a high-level overview of an interactive measurement processor that may be implemented in several modules depicted in FIG. 6. Process 800 may be used in some embodiments to measure the weight of a specified ingredient using the scale 110 and transmit this information to an interactive display 102. The process 800 begins at start block 805 and transitions to block 810, wherein the user interface device or interactive display sends a configuration command to the scale. This configuration command could be a command such as displaying the amount of the next ingredient to be weighed in a volumetric unit, such as cups. The configuration command could also be any other configuration command. The process then transitions to block 815, wherein the processor receives the signals from the user interface device or interactive display indicating a configuration command. The configuration command may include information as to whether the ingredient to be measured is a “key” ingredient. An ingredient indicated as a “key” ingredient signals to the scale that scaling of the ingredients of the recipe may be performed based on the weight of the key ingredient. Next, the process transitions to block 820, wherein the user places the ingredient to be weighed on the scale. The scale may prompt the user as to the next ingredient to be weighed or the user may reference a written recipe or recipe displayed on the interactive display. The scale then transmits the weight of the measured ingredient to the interactive display or user interface device in block 825. The transmission of this information may be done through a wired connection or wirelessly using a Bluetooth or other wireless connection. If the ingredient weighed was flagged as a key ingredient, the scale may also transmit a signal to the interactive display to scale the recipe based on the amount of the key ingredient.

The process 800 continues to block 830, wherein the weight or volume of the measured ingredient is displayed on the scale display. The user then removes the measured ingredient to a mixing bowl or other meal preparation area. If another ingredient is to be weighed, as indicated in decision block 835, process 800 transitions to block 810 and the process is repeated as described above. If no other ingredients are to be weighed, the process 800 transitions to block 840 and ends.

### Clarifications Regarding Terminology

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A configurable electronic scale, comprising:
a frame structure;
a measurement panel mounted on the frame structure;
at least one force sensor coupled to the frame structure and configured to measure a weight of an item placed on the measurement panel; and
a processor configured to convert the measured weight of the item into an equivalent volume and provide an indication of the amount of the item placed on the scale.

2. The scale of claim 1, wherein the scale further comprises a scale display mounted on the frame structure to display one or both of the weight and volume of the item.

3. The scale of claim 1, wherein the measurement panel comprises bezel-less transparent glass.

4. The scale of claim 1, wherein the measurement panel is detachably secured to the frame structure by a plurality of magnets.

5. The scale of claim 1, wherein the at least one force sensor comprises four force sensors mounted on each corner of the frame structure.

6. The scale of claim 5 wherein the processor is further configured to detect input from the force sensors and determine the weight of an item placed on the measurement panel.

7. The scale of claim 1, wherein the processor is further configured to access a conversion table stored within an electronic memory of the scale.

8. The scale of claim 1, wherein the scale is connected to an external interactive display.

9. The scale of claim 8, wherein the scale is connected to the external interactive display by a wireless connection.

10. The scale of claim 1, wherein the scale is configured to process voice commands.

11. A measurement system, comprising:
a display configured to display a recipe comprising at least one ingredient and a corresponding recipe ingredient amount; and
a scale in communication with the display, wherein the scale is configured to:
receive the recipe ingredient amount from the display,
measure an amount of ingredient placed on the scale by a user,
provide an indication of the amount of ingredient placed on the scale.

12. The measurement system of claim 11, wherein the recipe ingredient amount is specified as a volume, and wherein the display is further configured to convert the volume to a corresponding weight, and to send the corresponding weight to the scale.

13. The measurement system of claim 11, wherein the scale is further configured to scale a required measured amount of a second ingredient of a recipe based on a measured amount of a first ingredient of the recipe.

14. The measurement system of claim 13, wherein the scale is further configured to correct a required amount of the first ingredient of a recipe based on a measured amount of the second ingredient of the recipe.

15. A measurement system, comprising:
an interactive display configured to display a recipe comprising a plurality of ingredients, each of the plurality of ingredients having a corresponding recipe ingredient amount; and
a scale in communication with the display, wherein the scale is configured to:
measure an amount of a key ingredient placed on the scale by a user, wherein the key ingredient is one of the plurality of ingredients, and
provide the measured key ingredient amount to the display,
wherein the display is configured to scale the corresponding recipe ingredient amounts according to a ratio between an amount specified in the recipe for the key ingredient and the measured key ingredient amount.

16. The measurement system of claim 15, wherein the recipe ingredient amount is specified as a volume, and wherein the display is further configured to convert the volume to a corresponding weight value, and to send the corresponding weight value to the scale.

17. The measurement system of claim 15, wherein the recipe ingredient amount is specified as a volume and wherein the scale is further configured to convert the volume to a corresponding weight value, and to send the corresponding weight value to the interactive display.

18. The measurement system of claim 15, wherein the recipe ingredient amount is specified as a weight and wherein the scale is further configured to convert the weight to a corresponding volume value, and to send the corresponding volume value to the interactive display.

19. The measurement system of claim 15, wherein the scale is further configured to scale a required measured amount of a second ingredient of a recipe based on a measured amount of a first ingredient of the recipe.

20. The measurement system of claim 19, wherein the scale is further configured to correct a required amount of the first ingredient of a recipe based on a measured amount of the second ingredient of the recipe.

21. A method for weighing a series of recipe ingredients, comprising:
providing a configurable scale having a scale display and a measurement panel detachably secured to a frame structure, wherein a set of force sensors are configured to detect a weight of a first ingredient placed on the measurement panel;
receiving a configuration instruction from an interactive display;
weighing the first ingredient and displaying one or both of a weight and a volume of the first ingredient on the scale display;
transmitting one or both of the weight and volume of the first ingredient to the interactive display;
scaling a required weight or volume of a second ingredient based on the weight or volume of the first ingredient;
weighing the second ingredient and displaying one or both of a weight and a volume of the second ingredient on the scale display; and
transmitting one or both of the weight and volume of the second ingredient to the interactive display.

22. The method of claim 21, wherein receiving a configuration instruction includes receiving a task list of ingredients to be weighed.

23. The method of claim 22 further comprising displaying a name of an ingredient to be weighed on the scale display based on the task list.

24. The method of claim 21, wherein receiving a configuration instruction includes receiving a key ingredient instruction.

25. The method of claim 21, wherein the second ingredient is weighed while the first ingredient remains on the measurement panel.

26. The method of claim 21 further comprising adapting a recipe by scaling the weight or volume of the first ingredient based on the weight or volume of the second ingredient.
